(19) United States
(12) Patent Application Publication
(10) Pub. No.: US 2025/0211892 A1
(43) Pub. Date: Jun. 26, 2025

(54) METHOD, ELECTRONIC DEVICE, AND STORAGE MEDIUM FOR SHARING AUDIO DATA

(71) Applicant: GUANGDONG OPPO MOBILE TELECOMMUNICATIONS CORP., LTD., Dongguan (CN)

(72) Inventor: Ruitian HOU, Dongguan (CN)

(73) Assignee: GUANGDONG OPPO MOBILE TELECOMMUNICATIONS CORP., LTD., Dongguan (CN)

(21) Appl. No.: 19/075,626

(22) Filed: Mar. 10, 2025

Related U.S. Application Data
(63) Continuation of application No. PCT/CN2023/107261, filed on Jul. 13, 2023.

(30) Foreign Application Priority Data
Sep. 16, 2022 (CN) 202211130094.5

(51) Int. Cl. H04R 1/10

(52) U.S. Cl. CPC H04R 1/1091; H04R 2420/07

(57) ABSTRACT

A method, an electronic device, and a storage medium for sharing audio data. The method is performed by an electronic device. The electronic device establishes a Bluetooth low-energy connection with at least two Bluetooth devices, and the at least two Bluetooth devices do not belong to a same group. The method includes: setting the at least two Bluetooth devices to belong to a same group locally in the electronic device, in response to an audio sharing command; and sending the audio data to the at least two Bluetooth devices, in a case where the electronic device plays the audio data.

### CROSS-REFERENCE TO RELATED APPLICATIONS

The present application is a continuation-application of International (PCT) Patent Application No. PCT/CN2023/107261, filed on Jul. 13, 2023, which claims priority of Chinese Patent Application No. 202211130094.5, filed on Sep. 16, 2022, the entire contents of which are hereby incorporated by reference in their entireties.

### TECHNICAL FIELD

The present disclosure relates to the technical field of electronic devices, in particular to a method, an electronic device, and a storage medium for sharing audio data.

### BACKGROUND

With the development of science and technology, electronic devices are becoming more and more widely used and have more and more functions. They have become one of the necessities in people's daily lives. At present, the electronic devices can play audio data output through Bluetooth devices.

### SUMMARY OF THE DISCLOSURE

In view of the above problems, the present disclosure proposes a method, an electronic device, and a storage medium for sharing audio data to solve the above problems.

In a first aspect, the present disclosure provides a method for sharing audio data, performed by an electronic device; the electronic device establishes a Bluetooth low-energy connection with at least two Bluetooth devices, and the at least two Bluetooth devices do not belong to a same group; the method includes: setting the at least two Bluetooth devices to belong to a same group locally in the electronic device, in response to an audio sharing command; and sending the audio data to the at least two Bluetooth devices, in a case where the electronic device plays the audio data.

In a second aspect, the present disclosure provides an electronic device, including a processor and a memory; the memory is coupled to the processor, and the memory stores an instruction; the instruction is configured to be executed by the processor to perform the method as above.

In a third aspect, the present disclosure provides a computer-readable storage medium, storing program code; the program code is callable by a processor to perform the method as above.

### BRIEF DESCRIPTION OF THE DRAWINGS

In order to more clearly illustrate the technical solution in the embodiments of the present disclosure, the following is a brief description of the drawings needed to be used in the description of the embodiments. Obviously, the drawings described below are only some embodiments of the present disclosure. For those skilled in the art, without the expenditure of creative labor, other drawings can be obtained based on these drawings.

FIG. 1 is a schematic diagram of an application environment for a method for sharing audio data according to some embodiments of the present disclosure.

FIG. 2 is a flowchart of a method for sharing audio data according to some embodiments of the present disclosure.

FIG. 3 is a flowchart of a method for sharing audio data according to other embodiments of the present disclosure.

FIG. 4 is a flowchart of a method for sharing audio data according to further other embodiments of the present disclosure.

FIG. 5 is a flowchart of step S310 in the method as illustrated in FIG. 4.

FIG. 6 is a flowchart of a method for sharing audio data according to still other embodiments of the present disclosure.

FIG. 7 is a flowchart of a method for sharing audio data according to still other embodiments of the present disclosure.

FIG. 8 is a block diagram of an apparatus for sharing audio data according to some embodiments of the present disclosure.

FIG. 9 is a block diagram of an electronic device to perform a method for sharing audio data according to some embodiments of the present disclosure.

FIG. 10 shows a storage unit for storing or carrying program code for implementing a method for sharing audio data according to some embodiments of the present disclosure.

### DETAILED DESCRIPTION

In order to enable those skilled in the art to better understand the present disclosure, the technical solutions in the embodiments of the present disclosure will be described clearly and completely below in conjunction with the appended drawings.

As people's lives become richer, users have more and more electronic devices, and the technology of Bluetooth devices such as Bluetooth speakers and Bluetooth headsets (such as true wireless Bluetooth headsets (TWS)) is also rapidly advancing. At the same time, with the development of Bluetooth technology, Bluetooth low-energy audio (BLE Audio) technology brings people wireless audio services with lower power consumption, lower cost, higher quality, and lower latency.

Regarding the user listening to audio data via Bluetooth devices, one electronic device can often only send the audio data to one Bluetooth device (such as a pair of Bluetooth devices) and cannot send the audio data to multiple Bluetooth devices at the same time. However, there are often scenarios in life or work where the user of the Bluetooth device desires to share the audio data from the electronic device with other users. This requires the provision of corresponding technology to facilitate and reliably share the audio data in the electronic device with other users.

The BLE Audio provides a Coordinated Set Identification Profile (CSIP) protocol, which allows devices belonging to the same set to interact with an external device in a coordinated and synchronized manner. This protocol mainly describes how the external device can identify multiple independent devices in a group as the same set. For multiple devices belonging to the same set to be used simultaneously with the external device, each device needs to establish an independent LE-Audio connection with the external device. At the same time, judgement can be made according to obtained set identity information of each device, such as Set Identity Resolving Key (SIRK) value, such that devices with the same SIRK value can be grouped into a set. That is, the electronic device will consider Bluetooth devices with the same SIRK value as a group, and the electronic device will simultaneously transmit audio to all devices in the group when continuously outputting audio.

The inventor of the present disclosure has found that, to achieve that multiple Bluetooth devices can share the audio data transmitted by the electronic device, the factory settings need to be programmed with the same SIRK value for the multiple Bluetooth devices. However, this method will cause other surrounding Bluetooth devices to be mistakenly connected to the electronic device. Specifically, when the electronic device selects to connect to a Bluetooth device, the electronic device first establishes an LE-Audio connection with the Bluetooth device and obtains the SIRK value of the Bluetooth device. In this case, the Bluetooth device can work normally with the electronic device. The electronic device, upon receiving the prand field in the RSI value carried in the broadcast message of another Bluetooth device, will calculate whether the hash is the same as the hash field of the RSI value in the broadcast. When they are the same, the electronic device will automatically establish a LE-Audio connection with the other Bluetooth device.

The RSI value in the broadcast message contains the hash value and the prand field. The prand field contains a random part and a fixed part (i.e., the 1 and 0 at the end). The hash value can be calculated from the SIRK and the prand field. The electronic device calculates a hash value based on the SIRK of the connected Bluetooth device and the prand field of the RSI value carried in the broadcast message of the other Bluetooth device, and then compares the calculated hash value with the hash field of the RSI value in the broadcast message of the other Bluetooth device to determine whether the two are consistent. The calculation method can be expressed by the following formula: RSI generation: hash=sih (SIRK, prand), RSI=hash∥prand.

In response to the above problem, the inventor has discovered after long-term research and proposes a method, an apparatus, an electronic device, and a storage medium for sharing audio data provided by the embodiments of the present disclosure. By setting at least two Bluetooth devices to belong to the same group when audio data sharing is required, the sharing function of audio data can be realized, thereby improving the user experience and enhancing product competitiveness. The specific method for sharing audio data is described in detail in the following embodiments.

The following will explain an application environment for a method for sharing audio data according to some embodiments of the present disclosure.

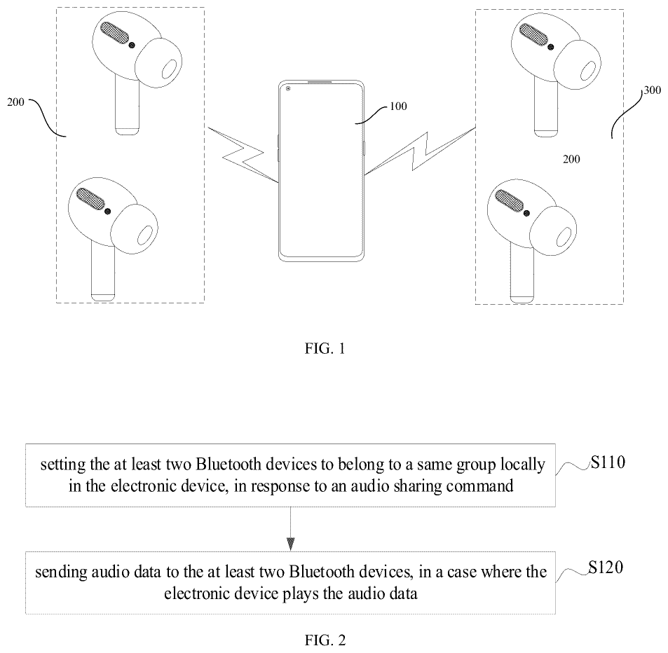

Referring to FIG. 1, FIG. 1 is a schematic diagram of an application environment for a method for sharing audio data according to some embodiments of the present disclosure. The application environment includes an electronic device 100, a first Bluetooth device 200, and a second Bluetooth device 300. Of course, it may further include a third Bluetooth device, a fourth Bluetooth device, etc., without limitation herein. The electronic device 100 may include audio source devices such as smartphones, tablets, laptops, personal computers, audio-visual equipment, wearable electronic devices, etc., without limitation. The first Bluetooth device 200 may include audio playback devices such as Bluetooth speakers and Bluetooth headsets, and the second Bluetooth device 300 may include audio playback devices such as Bluetooth speakers and Bluetooth headsets. When the first Bluetooth device 200 is a Bluetooth headset, the Bluetooth headset may include a single Bluetooth headset or a pair of Bluetooth headsets. When the second Bluetooth device 300 is a Bluetooth headset, the Bluetooth headset may include a single Bluetooth headset or a pair of Bluetooth headsets. As a means, a BLE connection may be established between the electronic device 100 and the first Bluetooth device 200, based on which information may be exchanged between the electronic device 100 and the first Bluetooth device 200; and a BLE connection may be established between the electronic device 100 and the second Bluetooth device 300, based on which information may be exchanged between the electronic device 100 and the second Bluetooth device 300.

The first Bluetooth device 200/second Bluetooth headset 300 is a Bluetooth device that supports LE Audio, and the electronic device 100 is an electronic device that supports LE Audio. As a means, the first Bluetooth device 200/second Bluetooth headset 300 supports a server role (unicast server) of LE Audio, and the electronic device 100 supports a client role (unicast client) of LE Audio. The unicast client is one of the LE Audio BAP roles, which is mainly configured to receive broadcasts for discovering the unicast server and establish a connection with the unicast server. The unicast server is another LE Audio BAP role, which is mainly configured to transmit broadcasts and establish a connection with the unicast client.

Referring to FIG. 2, FIG. 2 is a flowchart of a method for sharing audio data according to some embodiments of the present disclosure. The method is used to set at least two Bluetooth devices to belong to the same group when audio data sharing is required, such that the sharing function of audio data can be realized, thereby improving the user experience and enhancing product competitiveness. In a specific embodiment, the method for sharing audio data is applied to an apparatus 400 for sharing audio data shown in FIG. 8 and an electronic device 100 arranged with the apparatus 400 for sharing audio data (FIG. 9). The specific process of the embodiments will be explained below using the electronic device as an example. Of course, it is understood that the electronic device applied in the embodiments may include a smartphone, tablet, wearable electronic device, etc., which is not limited here. The following will provide a detailed explanation of the process shown in FIG. 2. In the embodiments, the electronic device establishes a Bluetooth low-energy connection with the at least two Bluetooth devices, and the at least two Bluetooth devices do not belong to the same group. The method for sharing audio data may specifically include operations at blocks illustrated herein.

At block S110: setting the at least two Bluetooth devices to belong to a same group locally in the electronic device, in response to an audio sharing command.

In the embodiments, a BLE connection may be established between the electronic device and the at least two Bluetooth devices, and the at least two Bluetooth devices do not belong to the same group. The at least two Bluetooth devices may be of the same type, for example, the at least two Bluetooth devices are both Bluetooth headsets; or the at least two Bluetooth devices may be of different types, for example, the at least two Bluetooth devices may include a Bluetooth headset and a smart speaker.

As a means, for each of the at least two Bluetooth devices, taking the Bluetooth device being a Bluetooth headset as an example, the Bluetooth headset may be placed in a headset case, and when the headset case is detected to be opened, a BLE connection between the electronic device and the Bluetooth headset may be established. As another means, the Bluetooth headset may be placed in the headset case, and when the Bluetooth headset is detected to be taken out from the headset case, a BLE connection between the electronic device and the Bluetooth headset may be established. As another means, the Bluetooth headset may be placed in the headset case, and when the Bluetooth headset is detected to be taken out from the headset case, it is detected whether the Bluetooth headset is being worn. When it is detected that the Bluetooth headset is being worn, a BLE connection between the electronic device and the Bluetooth headset may be established.

In the embodiments, the Bluetooth device can transmit a low-energy audio broadcast, and the electronic device can receive the low-energy audio broadcast transmitted by the Bluetooth device to obtain information about the Bluetooth device from the low-energy audio broadcast, such as the Bluetooth address of the Bluetooth device. After that, a BLE connection with the Bluetooth device can be established based on the Bluetooth address and other information about the Bluetooth device.

As a means, the Bluetooth headset may be placed in a headset case, and when the headset case is detected to be opened, a low-energy audio broadcast is transmitted. When the electronic device receives the low-energy audio broadcast, it establishes a BLE connection with the Bluetooth headset in response to the low-energy audio broadcast. As another means, the Bluetooth headset may be placed in a headset case, and when the Bluetooth headset is detected to be taken out from the headset case, a low-energy audio broadcast is transmitted. When the electronic device receives the low-energy audio broadcast, it establishes a BLE connection with the Bluetooth headset in response to the low-energy audio broadcast. As another means, the Bluetooth headset may be placed in a headset case, and when the Bluetooth headset is detected to be taken out from the headset case, it is detected whether the Bluetooth headset is being worn. When it is detected that the Bluetooth headset is being worn, a low-energy audio broadcast is transmitted. When the electronic device receives the low-energy audio broadcast, it establishes a BLE connection with the Bluetooth headset in response to the low-energy audio broadcast.

In some embodiments, for two Bluetooth headsets in a pair of Bluetooth headsets (e.g., a first Bluetooth headset and a second Bluetooth headset), the first Bluetooth headset and the second Bluetooth headset transmit LE-Audio broadcasts. After the user turns on the Bluetooth low-energy scanning of the electronic device, the LE-Audio broadcast transmitted by the first Bluetooth headset is scanned, and the user clicks on the link to the first Bluetooth headset. Then, a LE connection is established between the electronic device and the first Bluetooth headset. The electronic device initiates a service query with the first Bluetooth headset, establishes an LE-Audio connection with the first Bluetooth headset based on the service query result, and obtains the SIRK value from the first Bluetooth headset. The LE-Audio broadcast transmitted by the second Bluetooth headset is scanned, and the electronic device calculates a hash value based on the SIRK value of the first Bluetooth headset and the RSI value in the PRAND field of the LE-Audio broadcast transmitted by the second Bluetooth device. The electronic device determines whether the calculated hash value is the same as the hash field in the LE-Audio broadcast transmitted by the second Bluetooth headset. When they are the same, the electronic device establishes an LE connection with the second Bluetooth headset and initiates a service query to the second Bluetooth headset, and an LE-Audio connection is established with the second Bluetooth headset based on the service query result. Based on this, in a case where the first Bluetooth headset corresponds to the left ear and the second Bluetooth headset corresponds to the right ear, the first Bluetooth headset can receive left-channel audio data and the second Bluetooth headset can receive right-channel audio data.

In the embodiments, when it is determined that the electronic device has established BLE connections with at least two Bluetooth devices, it may be detected whether an audio sharing command is received. When it is determined that the audio sharing command is received, the electronic device may set the at least two Bluetooth devices to belong to the same group in response to the audio sharing command. That is, locally in the electronic device, the at least two Bluetooth devices are set to belong to the same group from not belonging to the same group. Based on this, at least two Bluetooth devices are set to belong to the same group locally on the electronic device, while the actual group of the at least two Bluetooth devices remains unchanged, that is, for the at least two Bluetooth devices themselves, they actually do not belong to the same group.

In some embodiments, the electronic device may detect whether it receives a target voice message, and in a case where it is determined that the target voice message is received, it can be determined that the audio sharing command is received. The electronic device may detect whether it receives a target touch operation, and in a case where it is determined that the target touch operation is received, it can be determined that the audio sharing command is received. The specific determination process is not limited to the above two options. The target touch operation may include a touch operation on a virtual control acting on the electronic device, a touch operation on a physical button acting on the electronic device, etc., without limitation. As a means, the touch operation on the virtual control may include: a click operation, a press operation, a slide operation, etc., and the touch operation on the physical button may include: a click operation, a press operation, etc., without limitation.

In some embodiments, the at least two Bluetooth devices are set to belong to the same group, where audio data received by the at least two Bluetooth devices belonging to the same group can be synchronized.

In some embodiments, the at least two Bluetooth devices may be set to belong to the same group by setting set identity information of the at least two Bluetooth devices recorded in the electronic device to the same set identity information. The set identity information may include, for example, a Set Identity Resolving Key (SIRK) value.

In some embodiments, the at least two Bluetooth devices may be set to belong to the same group by setting feature identity information of the at least two Bluetooth devices recorded in the electronic device to the same feature identity information. The feature identity information may include identity information, such as an identification code, configured to uniquely identify the Bluetooth device.

At block S120: sending audio data to the at least two Bluetooth devices, in a case where the electronic device plays the audio data.

In the embodiments, when the electronic device sets the at least two Bluetooth devices to belong to the same group, it may be detected whether the electronic device plays audio data. When it is detected that the electronic device plays the audio data, the electronic device sends the audio data to the at least two Bluetooth devices respectively. In this way, the sharing of audio data on the electronic device side may be achieved without relying on customized designs on the Bluetooth device side, which may enhance the sharing experience of audio data.

In some embodiments, the audio data played by the electronic device may include music audio data, video audio data, game audio data, etc., without limitation.

In some embodiments, when it is detected that the electronic device plays the audio data, the audio data may be sent to the at least two Bluetooth devices separately and simultaneously.

As a means, when the electronic device plays audio data, a connected isochronous stream (CIS) may be established between the electronic device and the at least two Bluetooth devices, and the audio data may be sent to the at least two Bluetooth devices based on the connected isochronous stream between the electronic device and the at least two Bluetooth devices.

The embodiments of the present disclosure provide a method for sharing audio data, which is applied to an electronic device that establishes a Bluetooth low-energy connection with at least two Bluetooth devices, where the at least two Bluetooth devices do not belong to the same group. The method includes: setting the at least two Bluetooth devices to belong to a same group locally in the electronic device, in response to an audio sharing command; and sending audio data to the at least two Bluetooth devices, in a case where the electronic device plays the audio data. In this way, when audio data sharing is required, the sharing function of audio data may be realized, thereby improving the user experience and enhancing the competitiveness of the product.

Referring to FIG. 3, FIG. 3 is a flowchart of a method for sharing audio data according to other embodiments of the present disclosure. The method is applied to the above-mentioned electronic device, which establishes a Bluetooth low-energy connection with at least two Bluetooth devices, and the at least two Bluetooth devices do not belong to the same group. The following will provide a detailed description of the process shown in FIG. 3. The method for sharing audio data may specifically include operations at blocks illustrated herein.

At block S210: setting the at least two Bluetooth devices to belong to a same group locally in the electronic device, in response to an audio sharing command.

For a detailed description of step S210, reference may be made to step S110, which will not be repeated herein.

At block S220: establishing a connected isochronous stream with each of the at least two Bluetooth devices, in a case where the electronic device plays audio data.

In the embodiments, a connected isochronous stream may be established with each of the at least two Bluetooth devices, when the at least two Bluetooth devices are set to belong to the same group and the electronic device plays audio data.

In some embodiments, in a case where the at least two Bluetooth devices are set to belong to the same group and the electronic device plays audio data, the electronic device may initiate an isochronous stream connection request to the at least two Bluetooth devices respectively, and the at least two Bluetooth devices may establish the connected isochronous stream with the electronic device in response to the isochronous stream connection request.

For example, the at least two Bluetooth devices include a first Bluetooth device and a second Bluetooth device. In a case where the first Bluetooth device and the second Bluetooth device are set to belong to the same group and the electronic device plays audio data, the electronic device may initiate a first isochronous stream connection request to the first Bluetooth device, and the first Bluetooth device may, in response to the first isochronous stream connection request, establish a connected isochronous stream with the electronic device; and the electronic device may initiate a second isochronous stream connection request to the second Bluetooth device, and the second Bluetooth device may, in response to the second isochronous stream connection request, establish a connected isochronous stream with the electronic device.

Taking the first Bluetooth device as a Bluetooth headset pair as an example, the first Bluetooth device may include a first Bluetooth headset and a second Bluetooth headset. When the first Bluetooth device and the second Bluetooth device are set to belong to the same group and the electronic device plays audio data, the electronic device may initiate a first isochronous stream connection request to the first Bluetooth headset, and the first Bluetooth headset may, in response to the first isochronous stream connection request, establish a connected isochronous stream with the electronic device. At the same time, the electronic device may initiate a second isochronous stream connection request to a second Bluetooth headset, and the second Bluetooth headset may, in response to the second isochronous stream connection request, establish a connected isochronous stream with the electronic device.

At block S230: sending the audio data to the at least two Bluetooth devices based on the connected isochronous stream with each of the at least two Bluetooth devices.

In the embodiments, in a case where the connected isochronous streams between the electronic device and at least two Bluetooth devices are successfully established, the audio data can be sent to the at least two Bluetooth devices based on the connected isochronous streams between the electronic device and the at least two Bluetooth devices.

In some embodiments, in a case where the connected isochronous stream between the electronic device and each of the at least two Bluetooth devices is successfully established, the audio data can be sent to the corresponding Bluetooth device based on the connected isochronous stream between the electronic device and each of the at least two Bluetooth devices. Taking the at least two Bluetooth devices including a first Bluetooth device and a second Bluetooth device as an example, the electronic device establishes a first connected isochronous stream with the first Bluetooth device and a second connected isochronous stream with the second Bluetooth device. The electronic device may then send the audio data to the first Bluetooth device based on the first connected isochronous stream and to the second Bluetooth device based on the second connected isochronous stream.

At block S240: in response to a control command sent by a first target Bluetooth device based on the connected isochronous stream corresponding to the first target Bluetooth device, controlling the electronic device and/or sending the control command to a Bluetooth device other than the first target Bluetooth device among the at least two Bluetooth devices; where the first target Bluetooth device is one of the at least two Bluetooth devices.

Since the electronic device and each of the at least two Bluetooth devices establish a connected isochronous stream, the electronic device can send information to the at least two Bluetooth devices based on the connected isochronous streams, and accordingly, the at least two Bluetooth devices can also send information to the electronic device based on the connected isochronous streams.

In some embodiments, each of the at least two Bluetooth devices may send a control command to the electronic device based on the connected isochronous stream between the Bluetooth device and the electronic device. In the embodiments, the Bluetooth device among the at least two Bluetooth devices that sends the control command to the electronic device can be determined as the first target Bluetooth device. The first target Bluetooth device can send the control command to the electronic device based on the connected isochronous stream between the Bluetooth device and the electronic device, and accordingly, the electronic device can, upon receiving the control command, perform an operation corresponding to the control command, and/or, send the control command to the Bluetooth device other than the first target Bluetooth device among the at least two Bluetooth devices in response to the control command, thereby achieving synchronization of the at least two Bluetooth devices.

As a means, the control command may include a music control command, and the electronic device may, in response to the music control command, control the playing, pausing, ending, etc., of the music, without limitation.

As another means, the control command may include a call control command, and the electronic device may, in response to the call control command, control answering and hanging up a call, etc., without limitation.

As further another means, the control command may include a Bluetooth device status command, and the electronic device may, in response to the Bluetooth device status command, update the Bluetooth device status information, for example, the remaining power of the Bluetooth device, the connection status of the Bluetooth device, etc., without limitation.

As yet another means, the control command may include a volume control command, and the electronic device may, in response to the volume control command, forward the volume control command to the Bluetooth device other than the first target Bluetooth device among the at least two Bluetooth devices to synchronize the volume of the at least two Bluetooth devices.

The embodiments of the present disclosure provide a method for sharing audio data, which includes: setting the at least two Bluetooth devices to belong to a same group locally in the electronic device, in response to an audio sharing command; establishing a connected isochronous stream with each of the at least two Bluetooth devices, in a case where the electronic device plays audio data; sending the audio data to the at least two Bluetooth devices based on the connected isochronous stream with each of the at least two Bluetooth devices; and in response to a control command sent by a first target Bluetooth device based on the connected isochronous stream corresponding to the first target Bluetooth device, controlling the electronic device and/or sending the control command to a Bluetooth device other than the first target Bluetooth device among the at least two Bluetooth devices; where the first target Bluetooth device is one of the at least two Bluetooth devices. Compared with the method for sharing audio data shown in FIG. 2, the present embodiments further establish a connected isochronous stream between the electronic device and each of the at least two Bluetooth devices, which may further improve the user experience and enhance the competitiveness of the product.

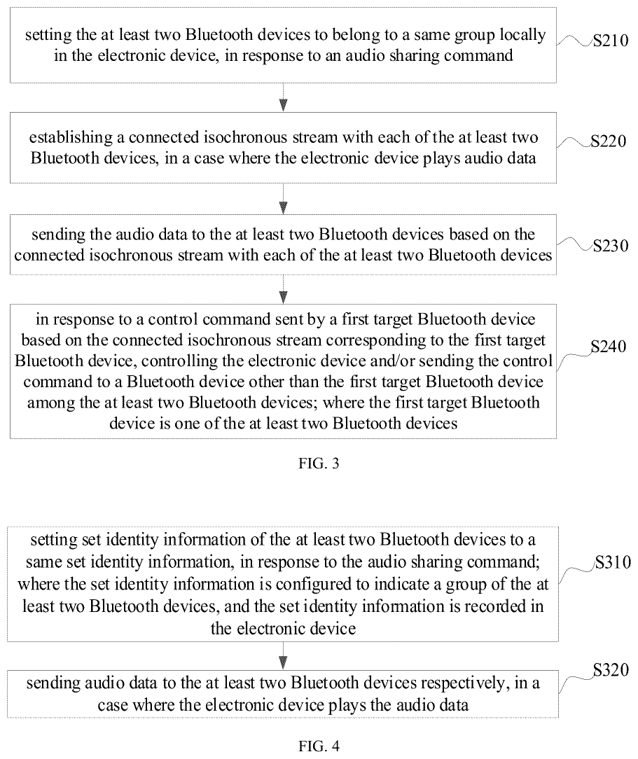

Referring to FIG. 4, FIG. 4 is a flowchart of a method for sharing audio data according to further other embodiments of the present disclosure. The method is applied to the above-mentioned electronic device, which establishes a Bluetooth low-energy connection with at least two Bluetooth devices, and the at least two Bluetooth devices do not belong to the same group. The following will provide a detailed description of the process shown in FIG. 4. The method for sharing audio data may specifically include operations at blocks illustrated herein.

At block S310: setting set identity information of the at least two Bluetooth devices to a same set identity information, in response to the audio sharing command; where the set identity information is configured to indicate a group of the at least two Bluetooth devices, and the set identity information is recorded in the electronic device.

The electronic device may pre-obtain the set identity information of the Bluetooth device and record the obtained set identity information of the Bluetooth device locally, and the set identity information of the Bluetooth device may be configured to indicate the group of the Bluetooth device. That is, Bluetooth devices with the same set identity information may be considered as belonging to the same group; whereas Bluetooth devices with different set identity information may be considered as not belonging to the same group. As a means, the set identity information includes a Set Identity Resolving Key (SIRK) value.

In the embodiments, in a case where the audio sharing command is received by the electronic device, the electronic device may set the set identity information locally recorded for the at least two Bluetooth devices to the same set identity information, in response to the audio sharing command, thereby achieving the setting of the at least two Bluetooth devices to belong to the same group. For example, the set identity information of the at least two Bluetooth devices is set to a target set identity information, such as setting the set identity information of the at least two Bluetooth devices to a target SIRK.

In the embodiments, in a case where the set identity information of the at least two Bluetooth devices is set to the same set identity information, the set identity information of the at least two Bluetooth devices may be stored as the same set identity information. That is, when the set identity information of the at least two Bluetooth devices is set to the same set identity information, the electronic device may store the same set identity information locally by itself and not set it to the at least two Bluetooth devices. The applicability of audio sharing may thus be improved without changing the design of the Bluetooth device side.

Referring to FIG. 5, FIG. 5 is a flowchart of step S310 in the method as illustrated in FIG. 4. The following will provide a detailed description of the process shown in FIG. 5. The method may specifically include operations at blocks illustrated herein.

At block S311: obtaining initial set identity information of each of the at least two Bluetooth devices, in response to the audio sharing command.

When a Bluetooth device is set at the factory, corresponding set identity information is generally burned in, and the set identity information burned in is different for different Bluetooth devices. When the Bluetooth device is a pair of Bluetooth headsets, the set identity information of two Bluetooth headsets in the pair of Bluetooth headsets is burned in as the same. For example, assuming that the at least two Bluetooth devices include a first Bluetooth device and a second Bluetooth device, the SIRK value of the first Bluetooth device at the factory may be burned in as SIRK1, and the SIRK value of the second Bluetooth device at the factory may be burned in as SIRK2.

As a means, the set identity information burned in for the Bluetooth device during factory settings may be taken as the initial set identity information of the Bluetooth device, and the initial set identity information of the first Bluetooth device may be SIRK1 and the initial set identity information of the second Bluetooth device may be SIRK2.

In the embodiments, the initial set identity information of the at least two Bluetooth devices may be obtained separately in response to receiving the audio sharing command. That is, in a case where the audio sharing command is received, the set identity information set during factory settings of the at least two Bluetooth devices may be obtained respectively, and taken as the initial set identity information of the at least two Bluetooth devices. For example, the SIRK1 of the first Bluetooth device may be obtained as the initial set identity information of the first Bluetooth device, and the SIRK2 of the second Bluetooth device may be obtained as the initial set identity information of the second Bluetooth device.

In some embodiments, in a case where the audio sharing command is received, the initial set identity information of the at least two Bluetooth devices may be obtained based on the BLE connections between the electronic device and at least two Bluetooth devices. In particular, in a case where the audio sharing command is received, a service query may be initiated to the at least two Bluetooth devices based on the BLE connections between the electronic device and at least two Bluetooth devices, and the initial set identity information of the at least two Bluetooth devices may be obtained based on the service query result. For example, the set identity information of the first Bluetooth device may be obtained based on the BLE connection with the first Bluetooth device, and the set identity information of the second Bluetooth device may be obtained based on the BLE connection with the second Bluetooth device.

In some embodiments, in a case where the audio sharing command is received, the set identity information of the at least two Bluetooth devices may be obtained locally from the electronic device. Then, before the obtaining the initial set identity information of each of the at least two Bluetooth devices in response to the audio sharing command, the method may further include: obtaining the initial set identity information of each of the at least two Bluetooth devices based on the BLE connections between the electronic device and at least two Bluetooth devices, and storing the initial set identity information of the at least two Bluetooth devices locally in the electronic device. Based on this, in a case where an audio sharing command is received subsequently, the set identity information of the at least two Bluetooth devices may be directly obtained from the electronic device locally.

At block S312: updating the set identity information of the at least two Bluetooth devices from the initial set identity information of the at least two Bluetooth devices to the same set identity information.

In the embodiments, after obtaining the set identity information of the at least two Bluetooth devices, the set identity information of the at least two Bluetooth devices may be updated from the respective initial set identity information to the same set identity information. The same set identity information may be the same as one of the initial set identity information or be different from all of the initial set identity information, without limitation.

In some embodiments, it is assumed that the at least two Bluetooth devices include a first Bluetooth device and a second Bluetooth device, and that the initial set identity information of the first Bluetooth device is SIRK1 and the initial set identity information of the second Bluetooth device is SIRK2. When the same combination identifier is SIRK3, the combination identifier of the first Bluetooth device may be updated from SIRK1 to SIRK3, and the combination identifier of the second Bluetooth device may be updated from SIRK2 to SIRK3. When the same combination identifier is SIRK1, the combination identifier of the first Bluetooth device may be maintained as SIRK1, and the combination identifier of the second Bluetooth device may be updated from SIRK2 to SIRK1. When the same combination identifier is SIRK2, the combination identifier of the first Bluetooth device may be updated from SIRK1 to SIRK2, and the combination identifier of the second Bluetooth device may be maintained as SIRK2.

In some embodiments, after updating the set identity information of the at least two Bluetooth devices from their respective initial set identity information to the same set identity information, the method may further include: in response to an audio stop sharing command, restoring the set identity information of each of the at least two Bluetooth devices from the target set identity information to the initial set identity information correspondingly. As a means, in a case of recovering the set identity information of the at least two Bluetooth devices from the target set identity information to their respective initial set identity information, the initial set identity information corresponding to each of the at least two Bluetooth devices may be stored locally in the electronic device.

In some embodiments, it is assumed that the at least two Bluetooth devices include a first Bluetooth device and a second Bluetooth device, and that the initial set identity information of the first Bluetooth device is SIRK1 and the initial set identity information of the second Bluetooth device is SIRK2. When the same set identity information is SIRK3, in response to the audio stop sharing command, the set identity information of the first Bluetooth device may be restored from SIRK3 to SIRK1 and the set identity information of the second Bluetooth device is may be from SIRK3 to SIRK2. When the same set identity information is SIRK1, the set identity information of the first Bluetooth device may be maintained as SIRK1 and the set identity information of the second Bluetooth device may be restored from SIRK1 to SIRK2. When the same set identity information is SIRK2, the set identity information of the set identity information of the first Bluetooth device may be restored from SIRK2 to SIRK1, and the set identity information of the second Bluetooth device may be maintained as SIRK2.

As a means, the response to the audio sharing stop command may include: the electronic device receiving a command message for indicating stopping audio sharing. The command message for stopping audio sharing may include, without limitation, a voice message for stopping audio sharing, a touch operation for stopping audio sharing, etc.

As another means, the response to the audio sharing stop command may include: the electronic device stopping playing the audio data. The electronic device stopping playing the audio data may include, without limitation, the electronic device pausing the audio data, the electronic device ending the audio data, etc.

As further another means, the response to the audio sharing stop command may include: the electronic device disconnecting the BLE connections with the at least two Bluetooth devices.

As yet another means, the response to the audio sharing stop command may include: the electronic device disconnecting the connected isochronous stream with each of the at least two Bluetooth devices.

At block S320: sending audio data to the at least two Bluetooth devices respectively, in a case where the electronic device plays the audio data.

For a detailed description of step S320, reference may be made to step S120, which will not be repeated herein.

The embodiments of the present disclosure provide a method for sharing audio data, which includes: setting set identity information of the at least two Bluetooth devices to a same set identity information, in response to the audio sharing command; where the set identity information is configured to indicate a group of the at least two Bluetooth devices, and the set identity information is recorded in the electronic device; sending audio data to the at least two Bluetooth devices respectively, in a case where the electronic device plays the audio data. Compared to the method for sharing audio data shown in FIG. 2, the present embodiments further set the set identity information of the at least two Bluetooth devices to the same set identity information, thereby setting the at least two Bluetooth devices to belong to the same device combination, thereby further improving the accuracy of the group setting.

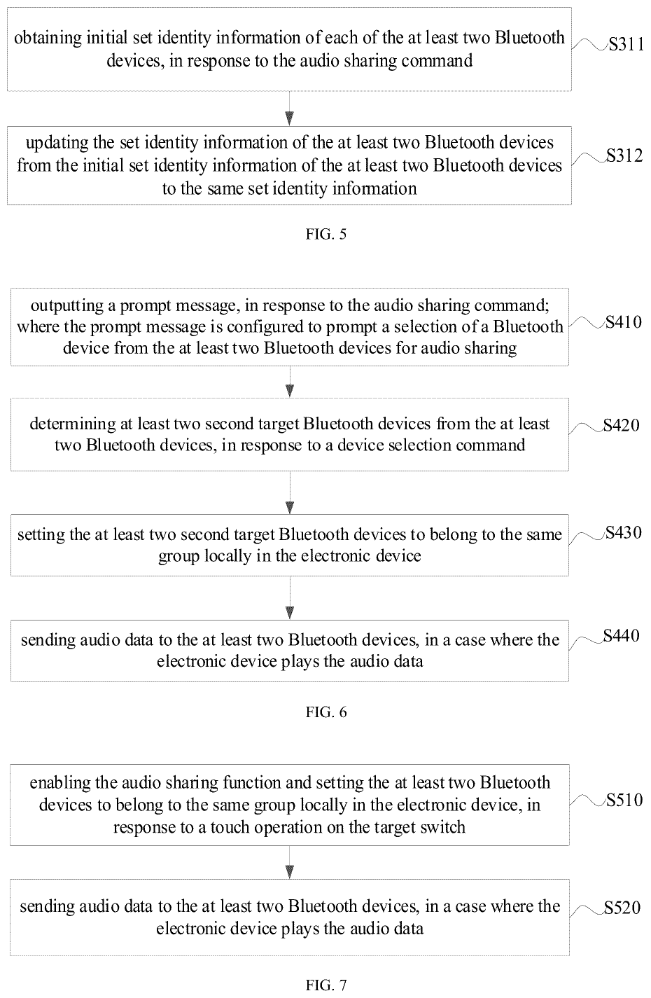

Referring to FIG. 6, FIG. 6 is a flowchart of a method for sharing audio data according to still other embodiments of the present disclosure. The method is applied to the above-mentioned electronic device, which establishes a Bluetooth low-energy connection with at least two Bluetooth devices, and the at least two Bluetooth devices do not belong to the same group. The following will provide a detailed description of the process shown in FIG. 6. The method for sharing audio data may specifically include operations at blocks illustrated herein.

At block S410: outputting a prompt message, in response to the audio sharing command; where the prompt message is configured to prompt a selection of a Bluetooth device from the at least two Bluetooth devices for audio sharing.

In the embodiments, in a case where the audio sharing command is received, a prompt message for prompting the selection of a Bluetooth device from the at least two Bluetooth devices for audio sharing may be output in response to the audio sharing command.

In some embodiments, the prompt information may include a voice prompt, a text prompt, a vibration prompt, etc., without limitation.

In some embodiments, in a case where the audio sharing command is received, the number of the at least two Bluetooth devices may be obtained. When the number of the at least two Bluetooth devices is two, the two Bluetooth devices may be determined as target Bluetooth devices. When the number of the at least two Bluetooth devices is greater than two, the prompt information may be output.

At block S420: determining at least two second target Bluetooth devices from the at least two Bluetooth devices, in response to a device selection command.

In the embodiments, in a case where the prompt message is output, it may be detected whether a device selection command triggered based on the prompt message is received. Where it is determined that the device selection command is received, the at least two second target Bluetooth devices may be determined from the at least two Bluetooth devices in response to the device selection command. Assuming that the at least two Bluetooth devices include a first Bluetooth device, a second Bluetooth device, a third Bluetooth device, and a fourth Bluetooth device, the prompt message may be configured to indicate selecting at least two Bluetooth devices from the first Bluetooth device, the second Bluetooth device, the third Bluetooth device, and the fourth Bluetooth device. The second Bluetooth device and the fourth Bluetooth device are determined as the second target Bluetooth device when the device selection command indicates that the second Bluetooth device and the fourth Bluetooth device are selected.

As a means, in a case where the prompt message is output, it may be detected whether a device selection command triggered based on the prompt message is received. When it is determined that a first abort device selection command triggered based on the prompt message is received, audio sharing may be stopped, i.e., stopping sending the audio data to the at least two Bluetooth devices respectively.

As another means, in a case where the prompt message is output, it may be detected whether a device selection command triggered based on the prompt message is received. When it is determined that a second device selection command triggered based on the prompt message is received, the at least two second target Bluetooth devices may be determined at random from the at least two Bluetooth devices.

As further another means, in a case where the prompt message is output, it may be detected whether a device selection command triggered based on the prompt message is received. When it is determined that no user-triggered selection command is received within a preset time, audio sharing may be stopped, i.e., stopping sending the audio data to the at least two Bluetooth devices respectively.

As yet another means, in a case where the prompt message is output, it may be detected whether a device selection command triggered based on the prompt message has been received. When it is determined that no user-triggered selection command is received within a preset time, the at least two second target Bluetooth devices may be determined at random from the at least two Bluetooth devices.

At block S430: setting the at least two second target Bluetooth devices to belong to the same group locally in the electronic device.

In the embodiments, in a case where the at least two target Bluetooth devices are determined, the at least two second target Bluetooth devices may be set to belong to the same group locally in the electronic device.

At block S440: sending audio data to the at least two Bluetooth devices, in a case where the electronic device plays the audio data.

For a detailed description of step S440, reference may be made to step S120, which will not be repeated herein.

The embodiments of the present disclosure provide a method for sharing audio data, which includes: outputting a prompt message, in response to the audio sharing command; where the prompt message is configured to prompt a selection of a Bluetooth device from the at least two Bluetooth devices for audio sharing; in response to a device selection command, determining at least two second target Bluetooth devices from the at least two Bluetooth devices; setting the at least two second target Bluetooth devices to belong to the same group locally in the electronic device; and sending audio data to the at least two Bluetooth devices, in a case where the electronic device plays the audio data. Compared with the method for sharing audio data shown in FIG. 2, the present embodiments further improve the user experience by allowing the user to select the Bluetooth device with which audio sharing is required.

Referring to FIG. 7, FIG. 7 is a flowchart of a method for sharing audio data according to still other embodiments of the present disclosure. The method is applied to the above-mentioned electronic device, which establishes a Bluetooth low-energy connection with at least two Bluetooth devices, and the at least two Bluetooth devices do not belong to the same group. The electronic device is arranged with a target switch for controlling the enabling or disabling of an audio sharing function. The following will provide a detailed description of the process shown in FIG. 7. The method for sharing audio data may specifically include operations at blocks illustrated herein.

At block S510: enabling the audio sharing function and setting the at least two Bluetooth devices to belong to the same group locally in the electronic device, in response to a touch operation on the target switch.

In the embodiments, the electronic device may be arranged with a target switch for controlling the enabling or disabling of the audio sharing function. That is, the user can control the enabling or disabling of the audio sharing function by touching the target switch. For example, the user can touch the target switch to set the target switch to a first state, in which case the audio sharing function is turned on, and touch the target switch to set the target switch to a second state, in which case the audio sharing function is turned off. As a means, the target switch may be presented in the form of a virtual control.

In some embodiments, the electronic device may detect a touch operation applied to the target switch. In a case where the touch operation applied to the target switch is detected, representing that the user expects to turn on the audio sharing function, the audio sharing function may be enabled in response to the touch operation applied to the target switch, and the at least two Bluetooth devices are set to belong to the same group in the electronic device.

At block S520: sending audio data to the at least two Bluetooth devices, in a case where the electronic device plays the audio data.

For a detailed description of step S520, reference may be made to step S120, which will not be repeated herein.

The embodiments of the present disclosure provide a method for sharing audio data, which includes: enabling the audio sharing function and setting the at least two Bluetooth devices to belong to the same group locally in the electronic device, in response to a touch operation on the target switch; and sending audio data to the at least two Bluetooth devices, in a case where the electronic device plays the audio data. Compared with the method for sharing audio data shown in FIG. 2, the present embodiments further control the enabling or disabling of the audio sharing function via the target switch, which may further improve the user experience.

Referring to FIG. 8, FIG. 8 is a block diagram of an apparatus for sharing audio data according to some embodiments of the present disclosure. The apparatus 400 for sharing audio data is applied to the above-mentioned electronic device, which establishes a Bluetooth low-energy connection with at least two Bluetooth devices, and the at least two Bluetooth devices do not belong to the same group. The following will provide a detailed description of the block diagram shown in FIG. 8. The apparatus 400 for sharing audio data may specifically include: a group setting module 410 and an audio data sharing module 420.

The grouping setting module 410 is configured to set the at least two Bluetooth devices to belong to a same group locally in the electronic device, in response to an audio sharing command.

Further, the grouping setting module 410 includes:
a first grouping setting sub-module, configured to set identity information of the at least two Bluetooth devices to a same set identity information, in response to the audio sharing command; where the set identity information is configured to indicate a group of the at least two Bluetooth devices, and the set identity information is recorded in the electronic device.

Further, the first grouping setting sub-module includes:
a first initial set identity information obtaining unit, configured to obtain initial set identity information of each of the at least two Bluetooth devices, in response to the audio sharing command; and
a grouping setting unit, configured to update the set identity information of the at least two Bluetooth devices from the initial set identity information of the at least two Bluetooth devices to the same set identity information.

Further, the first grouping setting sub-module further includes:
a set identity information restoring unit, configured to restore the set identity information of each of the at least two Bluetooth devices from the target set identity information to the initial set identity information correspondingly, in response to an audio stop sharing command.

Further, the set identity information restoring unit includes:
a first stop determination sub-unit, configured to determine that the electronic device receives a command message for indicating stopping audio sharing;
a second stop determination sub-unit, configured to determine that the electronic device stops playing the audio data;
a third stop determination sub-unit, configured to determine that the electronic device disconnects a BLE connection with each of the at least two Bluetooth devices; and
a fourth stop determination sub-unit, configured to determine that the electronic device disconnects a connected isochronous stream with each of the at least two Bluetooth devices.

Further, the grouping setting module 410 includes:
a prompt message output sub-module, configured to output a prompt message, in response to the audio sharing command; where the prompt message is configured to prompt a selection of a Bluetooth device from the at least two Bluetooth devices for audio sharing;
a target Bluetooth device determination sub-module, configured to determine at least two second target Bluetooth devices from the at least two Bluetooth devices, in response to a device selection command; and
a second grouping setting sub-module, configured to set the at least two second target Bluetooth devices to belong to the same group locally in the electronic device.

Further, the electronic device is arranged with a target switch for controlling the enabling or disabling of an audio sharing function, and the grouping setting module 410 further includes:
a third grouping setting sub-module, configured to enable the audio sharing function and set the at least two Bluetooth devices to belong to the same group locally in the electronic device, in response to a touch operation on the target switch.

The audio data sharing module 420 is configured to send audio data to the at least two Bluetooth devices, in a case where the electronic device plays the audio data.

Further, the audio data sharing module 420 includes:
a connected isochronous stream establishment sub-module, configured to establish a connected isochronous stream with each of the at least two Bluetooth devices, in a case where the electronic device plays audio data; and
an audio data transmission sub-module, configured to send the audio data to the at least two Bluetooth devices based on the connected isochronous stream with each of the at least two Bluetooth devices.

Further, the audio data sharing module 420 includes:
a control command response sub-module, configured to, in response to a control command sent by a first target Bluetooth device based on the connected isochronous stream corresponding to the first target Bluetooth device, control the electronic device and/or send the control command to a Bluetooth device other than the first target Bluetooth device among the at least two Bluetooth devices; where the first target Bluetooth device is one of the at least two Bluetooth devices.

It will be clear to those skilled in the art that, for the sake of convenience and conciseness of description, the specific working process of the above-described apparatus and modules can refer to the corresponding process in the aforementioned method embodiments, which will not be described in detail herein.

In the embodiments provided in the present disclosure, the coupling between modules may be electrical, mechanical, etc.

In addition, the functional modules in the various embodiments of the present disclosure may be integrated into a processing module or be physically present separately, or two or more modules may be integrated into one module. The above-mentioned integrated modules may be implemented in the form of either hardware or software functional modules.

Referring to FIG. 9, FIG. 9 is a block diagram of an electronic device to perform a method for sharing audio data according to some embodiments of the present disclosure. The electronic device 100 may be capable of running applications, such as a smartphone, tablet computer, e-book, etc. The electronic device 100 of the present disclosure may include one or more of the following components: a processor 110, a memory 120, and one or more applications, where the one or more of the applications may be stored in the memory 120 and configured to be executed by one or more processors 110 to perform the method as described in the foregoing method embodiments.

The processor 110 may include one or more processing cores. The processor 110 is connected to various parts of the entire electronic device 100 using various interfaces and lines, and executes various functions of the electronic device 100 and processes data by running or executing instructions, programs, code sets or instruction sets stored in the memory 120 and by calling data stored in the memory 120. Optionally, the processor 110 may be implemented in at least one of the hardware forms of digital signal processing (DSP), field-programmable gate array (FPGA), or programmable logic array (PLA). The processor 110 may integrate one or a combination of a central processing unit (CPU), a graphics processing unit (GPU), and a modem. The CPU is mainly configured to handle the operating system, user interface, and applications, etc.; the GPU is configured to render and draw the content to be displayed; and the modem is configured to handle wireless communication. It is understood that the above modem may not be integrated into the processor 110, and may be implemented separately by a communication chip.

The memory 120 may include random access memory (RAM) and may include read-only memory (ROM). The memory 120 may be configured to store instructions, programs, codes, code sets, or instruction sets. The memory 120 may include a program storage area and a data storage area, where the program storage area may store instructions for implementing the operating system, instructions for implementing at least one function (e.g., a touch function, a sound playback function, an image playback function, etc.), and instructions for implementing each of the method embodiments, etc. The storage data area may further store data created during use of the electronic device 100 (e.g., phonebook, audio and video data, chat history data, etc.).

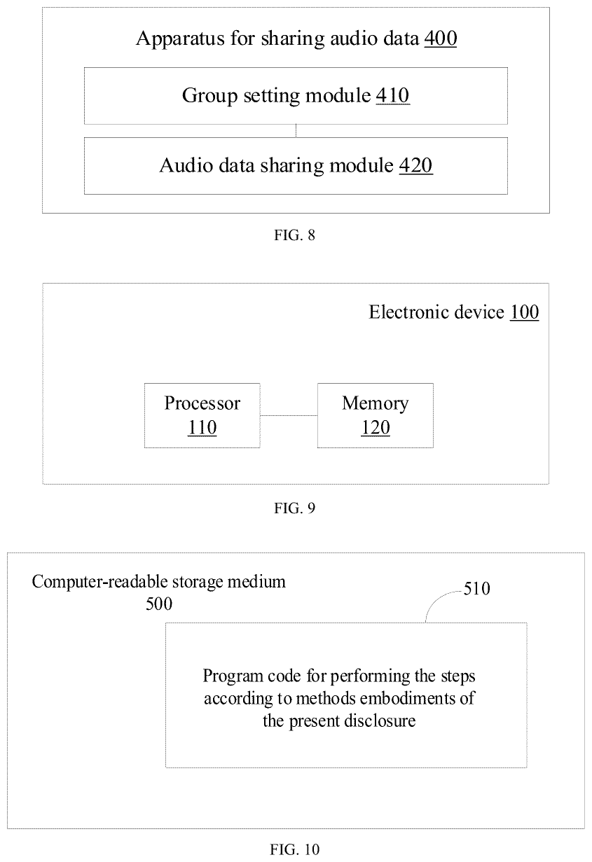

Referring to 10, FIG. 10 shows a storage unit for storing or carrying program code for implementing a method for sharing audio data according to some embodiments of the present disclosure. The computer-readable storage medium 500 stores program code, which may be executed by a processor to perform the methods described in the above embodiments.

The computer-readable storage medium 500 may be an electronic storage medium such as flash memory, electrically erasable programmable read-only memory (EEPROM), EPROM, hard disk, or ROM. Optionally, the computer-readable storage medium 500 includes a non-transitory computer-readable storage medium. The computer-readable storage medium 500 has storage space for program code 510 that performs any of the method steps in the above methods. This program code can be read from or written to one or more computer program products. The program code 510 may be compressed in an appropriate form.

In summary, the embodiments of the present disclosure provide a method, an apparatus, an electronic device, and a storage medium for sharing audio data, which is applied to an electronic device that establishes a Bluetooth low-energy connection with at least two Bluetooth devices, where the at least two Bluetooth devices do not belong to the same group. The method includes: setting the at least two Bluetooth devices to belong to a same group locally in the electronic device, in response to an audio sharing command; and sending audio data to the at least two Bluetooth devices, in a case where the electronic device plays the audio data. In this way, when audio data sharing is required, the sharing function of audio data may be realized, thereby improving the user experience and enhancing the competitiveness of the product.

Finally, it should be noted that the above embodiments are provided for the purpose of illustrating, rather than limiting, the technical solution of the present disclosure. Although the present disclosure has been described in detail with reference to the foregoing embodiments, those skilled in the art will understand that the technical solutions described in the foregoing embodiments may be modified, or some of the technical features may be replaced with equivalent alternatives; and that these modifications or replacements do not drive the essence of the corresponding technical solution out of the spirit and scope of the embodiments of the present disclosure.

What is claimed is:

1. A method for sharing audio data, performed by an electronic device; wherein the electronic device establishes a Bluetooth low-energy connection with at least two Bluetooth devices, and the at least two Bluetooth devices do not belong to a same group; the method comprises:
setting the at least two Bluetooth devices to belong to a same group locally in the electronic device, in response to an audio sharing command; and
sending the audio data to the at least two Bluetooth devices, in a case where the electronic device plays the audio data.

2. The method according to claim 1, wherein the sending the audio data to the at least two Bluetooth devices, in a case where the electronic device plays the audio data comprises:
establishing a connected isochronous stream with each of the at least two Bluetooth devices, in a case where the electronic device plays the audio data; and
sending the audio data to the at least two Bluetooth devices based on the connected isochronous stream with each of the at least two Bluetooth devices.

3. The method according to claim 2, after the establishing a connected isochronous stream with each of the at least two Bluetooth devices, in a case where the electronic device plays the audio data, further comprising:
in response to a control command sent by a first target Bluetooth device based on the connected isochronous stream corresponding to the first target Bluetooth device, performing at least one of:
controlling the electronic device; and
sending the control command to a Bluetooth device other than the first target Bluetooth device among the at least two Bluetooth devices; wherein the first target Bluetooth device is one of the at least two Bluetooth devices.

4. The method according to claim 1, wherein the setting the at least two Bluetooth devices to belong to a same group locally in the electronic device, in response to an audio sharing command comprises:
setting set identity information of each of the at least two Bluetooth devices to a same set identity information, in response to the audio sharing command; wherein the set identity information is configured to indicate a group of a corresponding one of the at least two Bluetooth devices, and the set identity information is recorded in the electronic device.

5. The method according to claim 4, wherein the setting set identity information of each of the at least two Bluetooth devices to a same set identity information, in response to the audio sharing command comprises:
obtaining initial set identity information of each of the at least two Bluetooth devices, in response to the audio sharing command; and
updating the set identity information of each of the at least two Bluetooth devices from the initial set identity information to the same set identity information.

6. The method according to claim 5, before the obtaining initial set identity information of each of the at least two Bluetooth devices, in response to the audio sharing command, further comprising:
obtaining the initial set identity information of each of the at least two Bluetooth devices based on the Bluetooth low-energy connection between the electronic device and the at least two Bluetooth devices, and storing the initial set identity information of each of the at least two Bluetooth devices locally in the electronic device.

7. The method according to claim 5, after the updating the set identity information of each of the at least two Bluetooth devices from the initial set identity information to the same set identity information, further comprising:
restoring the set identity information of each of the at least two Bluetooth devices from the same set identity information to the initial set identity information, in response to an audio stop sharing command.

8. The method according to claim 7, wherein the response to an audio stop sharing command comprises one of:
the electronic device receiving a command message for indicating stopping audio sharing;
the electronic device stopping playing the audio data;
the electronic device disconnecting the Bluetooth low-energy connection with the at least two Bluetooth devices; and
the electronic device disconnecting a connected isochronous stream with each of the at least two Bluetooth devices.

9. The method according to claim 4, wherein the set identity information comprises a set identity resolving key (SIRK) value.

10. The method according to claim 1, wherein the setting the at least two Bluetooth devices to belong to a same group locally in the electronic device, in response to an audio sharing command comprises:
outputting a prompt message, in response to the audio sharing command; wherein the prompt message is configured to prompt a selection of a Bluetooth device from the at least two Bluetooth devices for audio sharing;
determining at least two second target Bluetooth devices from the at least two Bluetooth devices, in response to a device selection command; and
setting the at least two second target Bluetooth devices to belong to the same group locally in the electronic device.

11. The method according to claim 10, wherein the outputting a prompt message, in response to the audio sharing command comprises:
in a case where the audio sharing command is received, obtaining a number of the at least two Bluetooth devices;
in a case where the number of the at least two Bluetooth devices is two, determining the two Bluetooth devices as target Bluetooth devices; and
in a case where the number of the at least two Bluetooth devices is greater than two, outputting the prompt information.

12. The method according to claim 10, further comprising:
stopping sending the audio data to the at least two Bluetooth devices, in a case where a first abort device selection command that is triggered based on the prompt message is determined to be received; or
stopping sending the audio data to the at least two Bluetooth devices, in a case where no selection command that is triggered based on the prompt message is determined to be received within a preset time.

13. The method according to claim 10, further comprising:
determining the at least two second target Bluetooth devices at random from the at least two Bluetooth devices, in a case where a first abort device selection command that is triggered based on the prompt message is determined to be received; or
determining the at least two second target Bluetooth devices at random from the at least two Bluetooth devices, in a case where no selection command that is triggered based on the prompt message is determined to be received within a preset time.

14. The method according to claim 1, wherein the electronic device is arranged with a target switch for controlling enabling or disabling of an audio sharing function; the setting the at least two Bluetooth devices to belong to a same group locally in the electronic device, in response to an audio sharing command comprises:
enabling the audio sharing function and setting the at least two Bluetooth devices to belong to the same group locally in the electronic device, in response to a touch operation on the target switch.

15. The method according to claim 1, wherein for a Bluetooth headset among the at least two Bluetooth devices, the Bluetooth headset is placed in a headset case, and the method further comprises:
establishing the Bluetooth low-energy connection between the electronic device and the Bluetooth headset, in a case where the headset case is detected to be opened.

16. The method according to claim 15, wherein the establishing the Bluetooth low-energy connection between the electronic device and the Bluetooth headset, in a case where the headset case is detected to be opened comprises:
establishing the Bluetooth low-energy connection between the electronic device and the Bluetooth headset, in a case where the headset case is detected to be opened and the Bluetooth headset is detected to be taken out from the headset case.

17. The method according to claim 16, wherein the establishing the Bluetooth low-energy connection between the electronic device and the Bluetooth headset, in a case where the headset case is detected to be opened and the Bluetooth headset is detected to be taken out from the headset case comprises:
detecting whether the Bluetooth headset is being worn, in a case where the headset case is detected to be opened and the Bluetooth headset is detected to be taken out from the headset case; and
establishing the Bluetooth low-energy connection between the electronic device and the Bluetooth headset, in a case where it is detected that the Bluetooth headset is being worn.

18. The method according to claim 1, for a Bluetooth headset among the at least two Bluetooth devices, further comprising:
receiving a low-energy audio broadcast transmitted by the Bluetooth device, and obtaining a Bluetooth address of the Bluetooth device from the low-energy audio broadcast; and
establishing the Bluetooth low-energy connection between the electronic device and the Bluetooth headset based on the Bluetooth address.

19. An electronic device, comprising a processor and a memory; wherein the electronic device establishes a Bluetooth low-energy connection with at least two Bluetooth devices, and the at least two Bluetooth devices do not belong to a same group; wherein the memory is coupled to the processor, and the memory stores an instruction; the instruction is configured to be executed by the processor to perform:
setting the at least two Bluetooth devices to belong to a same group locally in the electronic device, in response to an audio sharing command; and
sending the audio data to the at least two Bluetooth devices, in a case where the electronic device plays the audio data.

20. A computer-readable storage medium for an electronic device, storing program code; wherein the electronic device establishes a Bluetooth low-energy connection with at least two Bluetooth devices, and the at least two Bluetooth devices do not belong to a same group; wherein the program code is callable by a processor to perform:
setting the at least two Bluetooth devices to belong to a same group locally in the electronic device, in response to an audio sharing command; and
sending the audio data to the at least two Bluetooth devices, in a case where the electronic device plays the audio data.
